(19) United States
(12) Patent Application Publication
(10) Pub. No.: US 2012/0215390 A1
(43) Pub. Date: Aug. 23, 2012

(54) CONTROL METHOD FOR AUTOMATICALLY RAISING OPERATIONAL SPEED OF ENGINE OR MOTOR FOR ENERGY SAVING AND EXTENSION OF AUTOMOBILE LIFESPAN

(76) Inventor: SHIUAN-SHENG WANG, Taipei City (TW)

(21) Appl. No.: 13/029,123

(22) Filed: Feb. 17, 2011

(51) Int. Cl. B60W 10/08; B60W 10/00; B60W 10/06

(52) U.S. Cl. 701/22; 701/54

(57) ABSTRACT

Provided is a control method for automatically raising rotational speed, in which two sensors are respectively mounted to power input side and power output side of a torque converter for detecting the rotational speeds of an impellor wheel and a runner wheel of the torque converter. The two sensors are connected to an on-automobile computer, which comprises a control device that raises the rotational speed of the engine or motor of the automobile, when a gearshift lever of the automobile is switched from a neutral position into a drive position under the condition that the automobile is in the neutral position and is moved by inertia thereof at a speed higher than 35 KM/H, order to cause an increase of the rotational speed of the impellor wheel to have the rotational speed of the impellor wheel slightly lower than the runner wheel with a rotational speed difference less than 300 rpm.

### TECHNICAL FIELD OF THE INVENTION

The present invention generally relates to a control method for automatically raising operational speed of engine or motor for energy saving and extension of automobile lifespan, which controls the speed difference between the impellor wheel and the runner wheel of a torque converter so that when the gearshift lever of a car is switched from the neutral position into the drive position under the condition that the car is in the neutral position and is allowed to “inertia-drive” at a speed higher than 35 KM/H, the rotational speed of the engine or motor of the car is raised to have the impellor wheel of the torque converter increased to a level slightly lower than the rotational speed of the runner wheel with a rotational speed difference less than 300 rpm, whereby the fluid temperature of the automatic transmission box will not greatly increased and stable engagement can be achieved, and also, the lifespan of car transmission box is extended, risk of damage of the transmission box is reduced, and unnecessary loss of kinetic energy of car is reduced, due to no high temperature being generated.

### DESCRIPTION OF THE PRIOR ART

Most of the cars available in the market are automatic transmission vehicles for making driving easy and convenient for regular drivers. The automatic transmission allows a driver to more easily change the position of gearshift lever without any concern of simultaneous operation of a clutch as required in a manual transmission vehicle. In other words, the driver only needs to set the gearshift lever in the “drive” position to easily operate the car to move forward and the driver is totally free of the concern of simultaneously operating a clutch. When it needs to stop the travel of the car for a longer while, such as stopping before a traffic light, the driver can simply switch the gearshift lever to the “neutral” position. When it needs to re-start the travel of the car, the driver moves the gearshift lever to the “drive” position again and then treads down the gas pedal, and the car moves forwards. The automatic transmission provides an easy way of driving, so that for most of the time of driving, the driver leaves the gearshift lever at the drive position. This makes it impossible to have the engine or motor of the car operated in such a way to correspond to the various situations of roads or streets. For example, when the traffic light ahead turns into red light, driving requires no additional power, but setting the gearshift lever in the drive position still keeps the engine or motor in high speed operation. This causes a waste of kinetic energy and also causes unnecessary consumption of fuel and additional wear of moving parts. For an automatic transmission box, an impellor wheel and a runner wheel are repeatedly switched between engaged condition and disengaged condition. This causes fast abrasion of surface teeth and may eventually fail functioning, leading to slipping. Such damage may get severe when the rotational speed difference between the two is great.

To save fuel, some drivers are used to switching the gearshift lever to the neutral position when they see a red sign of traffic light ahead and leaves the car “inertia-driving” to the traffic light. When it then requires power again, the gearshift lever is switched to the drive position again for further travel of the car. This operation helps reducing unnecessary fuel consumption, but it may cause a problem for it needs, at the time when power is required, to switch the gearshift lever from the neutral position to the drive position while the car is still moving in a substantial speed. The impeller wheel of torque converter that is connected to the engine or motor of the car and the counterpart runner wheel that are connected to the car wheels might be of a substantial speed difference therebetween. For example, the rotational speed of the runner wheel might be much higher than that of the impellor wheel. A sudden engagement between the two may cause a great abrasion therebetween, leading to fast increase of fluid temperature inside the transmission box, as well as unnecessary wear of the parts contained in the transmission box due to being acted upon by great impact forces. Eventually, the lifespan of the transmission box is shortened. Further, reflection of power caused by the sudden engagement may be transmitted to and thus damage the engine or motor coupled to the impellor wheel, also leading to shortening of lifespan.

### SUMMARY OF THE INVENTION

The primary objective of the present invention is to provide a control method for automatically raising rotational speed, which helps controlling the temperature of an automatic transmission box not to fast and greatly increase and to reduce the potential risk of damage of parts of the transmission box, so as to extend the lifespan of the transmission box.

Another objective of the present invention is to provide a control method for automatically raising rotational speed, which helps protecting the engine or motor that supplies power to an automobile from being damaged by improper reaction of external force so as to improve the life span thereof.

A further objective of the present invention is to provide a control method for automatically raising rotational speed, which helps reducing fuel consumption of automobiles and thus saving energy.

To achieve the above objectives, the present invention provides a control method for automatically raising rotational speed, which is operated with such a structure that sensors are respectively mounted to power input side and power output side of a torque converter for detecting the rotational speeds of an impellor wheel and a runner wheel of the torque converter. The two sensors are connected to an on-automobile computer, which comprises a control device that raises the rotational speed of the engine or motor of the automobile, when a gearshift lever of the automobile is switched from a neutral position into a drive position under the condition that the automobile is in the neutral position and is allowed to “inertia-drive” at a speed higher than 35 KM/H, in order to cause an increase of rotational speed of the impellor wheel so that the rotational speed of the impellor wheel of the torque converter is slightly lower than the runner wheel with a rotational speed difference less than 300 rpm, whereby impact force can be reduced and early damage of parts of the transmission box due to great impact force is eliminated.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view illustrating a control method for automatically raising rotational speed of engine or motor for energy saving and extension of automobile lifespan according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

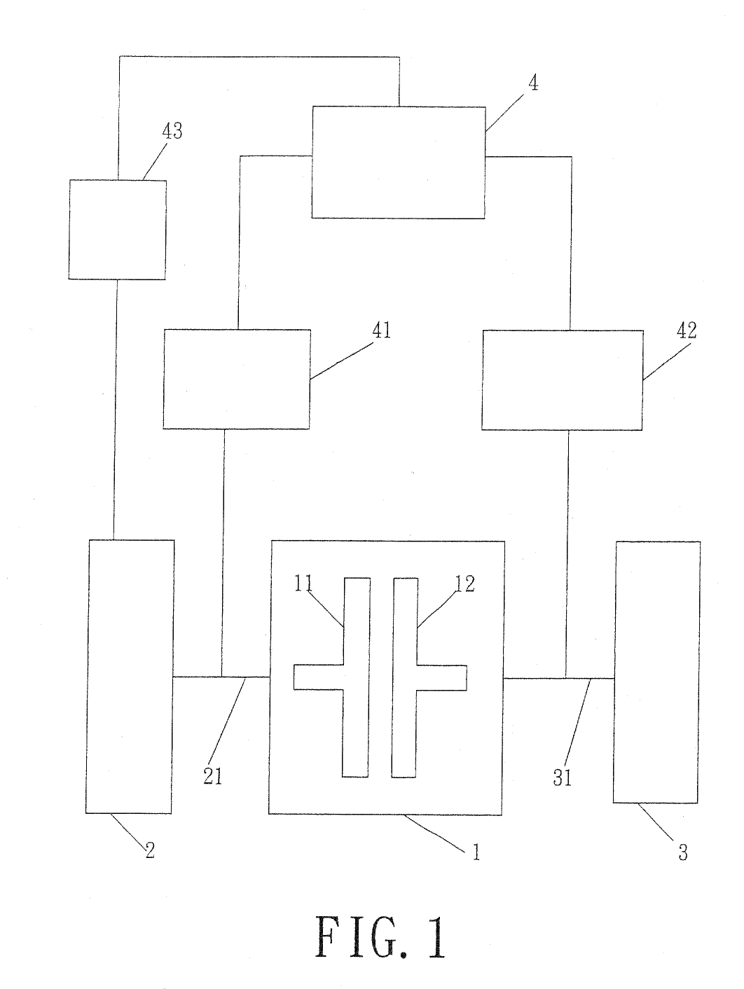

FIG. 1 is a schematic view illustrating a control method for automatically raising rotational speed of engine or motor for energy saving and extension of automobile lifespan according to the present invention, and a simplified schematic view showing transmission of power with a torque converter 1 is presented. The torque converter 1 comprises an impellor wheel 11 and a runner wheel 12 both contained in the torque converter 1. When the impellor wheel 11 and the runner wheel 12 engage each other, a coupled condition for transmission of power is formed. The impellor wheel 11 of the torque converter 1 is connected, externally, a connection mechanism 21, which is connected to an engine or motor 2 that supplies mechanical power to the automobile. The runner wheel 12 of the torque converter 1 is connected, externally, another connection mechanism 31, which is connected to wheels 3 of the automobile. In other words, the transmission system is set up in such a way that the mechanical power generated by the engine or motor 2 is transmitted through the first connection mechanism 21, the impellor wheel 11 and the runner wheel 12 of the torque converter 1, and the second connection mechanism 31 to the wheels 3 for driving the automobile to move forward.

The essence of the present invention is that a sensor 41 is mounted to the first connection mechanism 21 connecting between the impellor wheel 11 and the engine or motor 2 in order to instantaneously detect, either directly or indirectly, an actual rotational speed of the impellor wheel 11. Another sensor 42 is mounted to the second connection mechanism 31 connecting between the runner wheel 12 and the wheels to instantaneously detect, either directly or indirectly, an actual rotational speed of the runner wheel 12. Both sensors 41, 42 are connected to an on-automobile computer 4 of the automobile. The computer 4 comprises a control device 43, which performs instantaneous control of the rotational speed of the engine or motor 2, so as to control the rotational speed of the impellor wheel 11 of the torque converter 1 through the connection of the first connection mechanism 21.

According to the present invention, the goal of invention is achieved by changing the rotational speed of the power source (the impellor wheel 11) and the principle of operation will be described as follows. When a driver switches the gearshift lever of the automobile to the neutral position because of some reasons to allow the automobile to move by inertia thereof at a given speed, the impellor wheel 11 and the runner wheel 12 are caused to disengage from each other, so that the impellor wheel 11 stays in a regular idle condition, which shows a rotational speed of around 700-900 rpm in a tachometer, but the runner wheel 12 is driven to maintain rotating by the wheels 3 that are moving at a given speed, such as 35-90 KM/H, with a rotational speed much higher than that of the impellor wheel 11. When the driver desires power again and thus switches the gearshift lever to the drive position, a sudden engagement is formed between the impellor wheel 11 and the runner wheel 12 due to the large difference in rotational speed therebetween, thereby leading to excessive abrasion and fast increase of internal temperature of the torque converter 1. This shortens the lifespan of the automatic transmission box. On the other hand, according to the present invention, two sensors 41, 42 are provided to timely monitor the actual rotational speeds of the impellor wheel 11 and the 12, so that when the gearshift lever is switched from the neutral position to the drive position, the results of detection from the two sensors 41, 42 are supplied to the on-automobile computer 4. With the efficient computation operation performed by the computer 4, an output signal is generated and supplied to the control device 43 to have the engine or motor 2 to immediately increase the speed thereof, which in turn increases the rotational speed of the impellor wheel 11 to a level slightly lower than the rotational speed of the runner wheel 12 with the speed difference being controlled to be less than 300 rpm. With such a control, the problems discussed previously can be effectively eliminated.

As compared to the state-of-the-art technology, the control method for automatically raising rotational speed according to the present invention provides the following advantages:

(1) The present invention allows for instantaneous control of the rotational speed of the impellor wheel of the torque converter so that the abrasion occurring between the impellor wheel and the runner wheel can be alleviated and the potential risk of fast increase of temperature of automatic transmission box is reduced to thereby increase the lifespan thereof.

(2) Due to the instantaneous control of the rotational speed of the impellor wheel of torque converter realized by the present invention, the potential risk of kinetic energy transmitted from the runner wheel back to the impellor wheel and the engine or motor is eliminated and protection of the engine or motor can be realized.

(3) With the control of relative rotational speed between the impellor wheel and the runner wheel of the torque converter realized by the present invention, gear shifting operation of the automatic transmission mechanism can be made smooth and gentle to provide a proper rotational speed that matches the current moving speed of the automobile so that fuel consumption is reduced.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A control method for automatically raising rotational speed of the engine or motor for energy saving and extension of automobile lifespan, a sensor being mounted to each of input side and output side of a torque converter of an automobile, the two sensors being connected to an on-automobile computer, which comprises a control device that functions to selectively increase the rotational speed of the engine or motor instantaneously to thereby control and rotational speed of the impellor wheel.

2. The control method according to claim 1, wherein the rotational speed of the engine or motor is increased at a time when a gearshift lever is switched from a neutral position to a drive position under the condition that the automobile is in the neutral position and is moved by inertia thereof at a speed higher than 35 KM/H, so that the rotational speed of the impellor wheel is controlled to have the rotational speed of the impellor wheel of the torque converter slightly lower than the rotational speed of the runner wheel with a difference in rotational speed being less than 300 rpm.
